(19) United States
(12) Patent Application Publication
(10) Pub. No.: US 2004/0172307 A1
(43) Pub. Date: Sep. 2, 2004

(54) Electronic medical record method

(76) Inventor: Martin A. Gruber, Lido Beach, NY (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/773,738

(22) Filed: Feb. 6, 2004

Related U.S. Application Data
(60) Provisional application No. 60/445,584, filed on Feb. 6, 2003.

(51) Int. Cl. G06F 17/60

(52) U.S. Cl. 705/3

(57) ABSTRACT

An internet-based, patient-centric and patient controlled electronic medical record and systems and methods for managing the patient-centric and patient controlled electronic medical record. To ensure robustness of data and interchangeability of data the present invention is preferably implemented using open source software. Because the present invention is patient controlled, privacy of data is assured. The present invention contemplates entering data into the medical record from the physician's office, the laboratory, ancillary medical personnel, and the hospital. In another aspect translation of existing information applicable to the individual patient (legacy data) into the patient-centric electronic medical record are contemplated.

### RELATED APPLICATIONS

The present application claims priority to U.S. Provisional application 60/445,584 filed on Feb. 6, 2003, which is incorporated by reference herein.

### BACKGROUND OF THE INVENTION

1. Field of the Invention

The present invention relates, in general, to medical records, and, more particularly, to software, systems and methods to implement a electronic patient centered and patient controlled medical record system that protects patient privacy, dramatically reduces the incidence of medical errors in both the hospital and the physicians office, and increases the efficiency of both hospital and office practices.

2. Relevant Background

Present electronic medical record systems are provider-based and are, for the most part based on proprietary software. This produces several inefficiencies:

The record systems of competing providers are not compatible with each other so that electronic transfer of records among providers is not possible and frequently is not desirable from the point of view of the provider because of the loss of a competitive advantage. The companies providing the software are not immortal. Bankruptcy and mergers allow the software to become orphaned and no longer legible. Because the life expectancy of any given software system is much less than the life expectancy of the individual owner (i.e. the patient), the development of a patient centered, lifetime medical record system has been impossible with conventional systems.

When information is stored in local databases or under provider control, transfer of information among providers, essential to ideal medical care, is inhibited. Information transfer is delayed under the best of circumstances and often becomes totally unavailable. Most medical errors are related to failures of communication among providers. Because of this fragmentation, present systems, electronic or manual tend to amplify the risk of medical error. These problems have been known for some time, yet no universal viable system of electronic medical records has emerged.

Once cause is physician resistance. Present medical record systems are awkward to use, they are time consuming, they frequently do not have an immediate obvious benefit to the physician. Moreover, they require a significant time investment to learn and a significant financial commitment to maintain. There is no carry-over between hospital and office.

Another cause relates to competition. Competition between institutions and between providers produces a disincentive for information sharing. There has been an implicit belief that institutions must protect their investment in creating electronic records by preventing the distribution of those records to other institutions.

Further, systems are expensive, they tend to develop on an ad hoc basis so that a given institution may have separate systems for laboratory, radiology, billing and patient records. Hospitals traditionally have used hand-written clinical records divided into administrative, physician and nursing sections with individual prerogatives jealously guarded. These balkanizing forces have tended to discourage efforts to provide uniform, universal electronic medical records systems.

Social and scientific pressures are now emerging which are forcing a new outlook for the development of electronic medical records. It is clear that this field is due for rapid change. Pressures are now further increased by Federal requirements for standardized vocabulary, patient privacy and correction of medical errors. This will demand a new record system to be in place for all providers in the future. There are now many firms and systems in the marketplace seeking to enter this field. No system has emerged so far that has been able to overcome the objections listed above.

### SUMMARY OF THE INVENTION

The present invention addresses the limitations of the prior art in that the system in accordance with the present invention is Internet-based, patient-centered, patient-controlled, provider-funded and open source. This unique combination promotes acceptance by patients, physicians and institutions and allows all to experience the benefits of a complete, comprehensive, easily available, and robust lifetime medical record.

### BRIEF DESCRIPTION OF THE DRAWINGS

FIG. 1 shows entities and relationships in an implementation of the patent-centric, patient controlled medical records system in accordance with the present invention;

FIG. 2 shows entities and relationships in an implementation of the patent-centric, patient controlled medical records system in accordance with the present invention; and

FIG. 3 illustrates an Internet-based medical record system in accordance with the present invention.

### DETAILED DESCRIPTION OF THE PREFERRED EMBODIMENTS

The present invention provides an electronic, patient controlled, lifetime medical record which is designed to be portable, consistent and complete. Our system fulfills the recently imposed federal (HIPAA) regulations regarding patient privacy. The system is based on a patient controlled but hospital financed record system, which is made accessible to the hospital physician medical staff members for use in their private offices. The system includes modules to access laboratory, imaging (X-ray, MRI, CAT etc), and ancillary provider information. Previous efforts to develop a clinical medical record system have failed because of lack of acceptance by physicians. From the physician's point of view, the investment in both time and money was too great for the meager financial and practice benefits to encourage the general adoption of an electronic clinical record system by physicians.

The present invention comprises a patient centered and patient controlled internet enabled database containing the complete lifetime medical record for that individual. With patient permission, it allows any authorized health care provider to write directly into the system, authorization to read from or copy data from the system can only be provided by the patient and he/she can limit access to any portion of the database. The database is encrypted and stored on a web server, accessible (with patient permission) from anywhere in the world. The present invention overcomes the objections listed above.

Preferably, the present invention utilizes freely available Open Source public software to implement its system. (e.g., XML, MySql etc). The use of open source software guarantees that the software remains legible with the passage of time and eliminates the risk of data loss with the failure of the provider's business.

The present invention is Internet-based. A properly encrypted Internet-based system allows access from anywhere that the Internet is available (essentially the entire civilized world). Because this is a distributed database, it is robust and independent of the failure of any individual server or any other piece of hardware. Internet-based records enables transmission of information among the various health care providers easy, efficient and quick. Internet-based records allow significant information (allergies, previous illnesses, surgery etc.) to be immediately available to healthcare providers where-ever the patient may require treatment. Specific medical indications and contraindications (including age related idiosyncrasies) are part of the record and can be linked to appropriate databases (e.g. drug incompatibilities, and age related dosage table) to prevent medical errors. In emergency situations, the medical record is available in any office or emergency department equipped with a computer and a modem.

Significantly, the electronic medical record in accordance with the present invention is patient centered and patient controlled. This means that the individual controls (by means of password or other key) access to the medical record. Various agents and entities that may desire access to the patient record can be given patient-determined permissions to view some or all data within the electronic medical record. Patient privacy is automatic while access by needed health care entities is not inhibited.

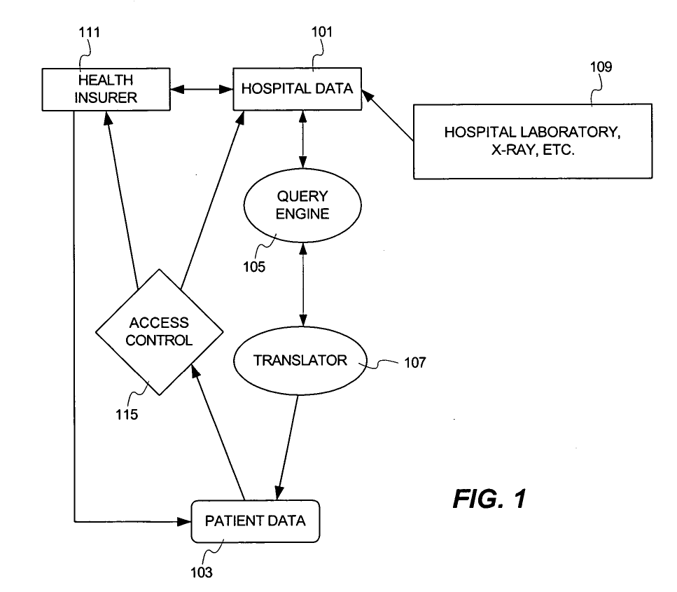

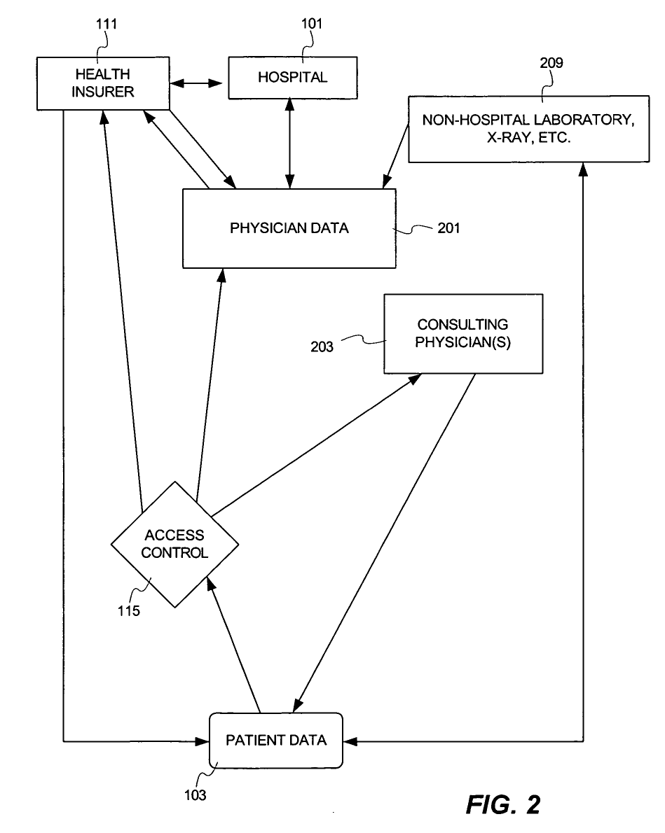

Referring to FIG. 1 and FIG. 2, a hospital database 101 typically includes: a variety of records 109 including previous hospital admission records, laboratory studies, imaging data reports (X-ray, MRI, Ultrasound, etc), surgical records and demographic information. This and any other pertinent information is transferred to the Patient Centered Medical Record 103 by query of the legacy database 101 utilizing a query engine 105 and translator module 107 which may use, for example, Standard Query Language (SQL) to obtain the data and a client optimized dictionary to translate the data into the standardized format.

Access to the patient data 103 is patient controlled by access control systems 115. Various levels of permission are contemplated. These include read and write permission, read only permission, write only permission. Read and write permission may be restricted by the patient to specific sectors of the record to specific agents or to specific times of entry to retain privacy of other sectors. Information is preferably stored in encrypted format in protected servers. Local computers used for data entry and evaluation are able to decrypt data only if a private key is provided by the data owner (the patient). The software to encrypt and decrypt the data is provided on a need-to-use basis to the local computer by the secure server and in particular implementations the encryption/decryption software is expired or deleted from the local computer when the local computer complete access of the electronic medical record. The local computer preferably holds unencrypted data only in volatile memory, sending and receiving encrypted data to and from the secure server (i.e. “thin client” format). The encryption and decryption software provided by the server is preferably automatically deleted from the local computer when it is no longer needed. Strict authentication of the various agents who access the record is maintained. This is provided, for example, by password control but the present invention is readily adapted to more sophisticated and reliable methods as these techniques become available. Those portions of the database entered by a specific author (physician, hospital, etc) may be retained as part of the records of that author, but reading and/or copying of any other portion of the record requires the permission of the patient. Hence, insurer 111 may be given

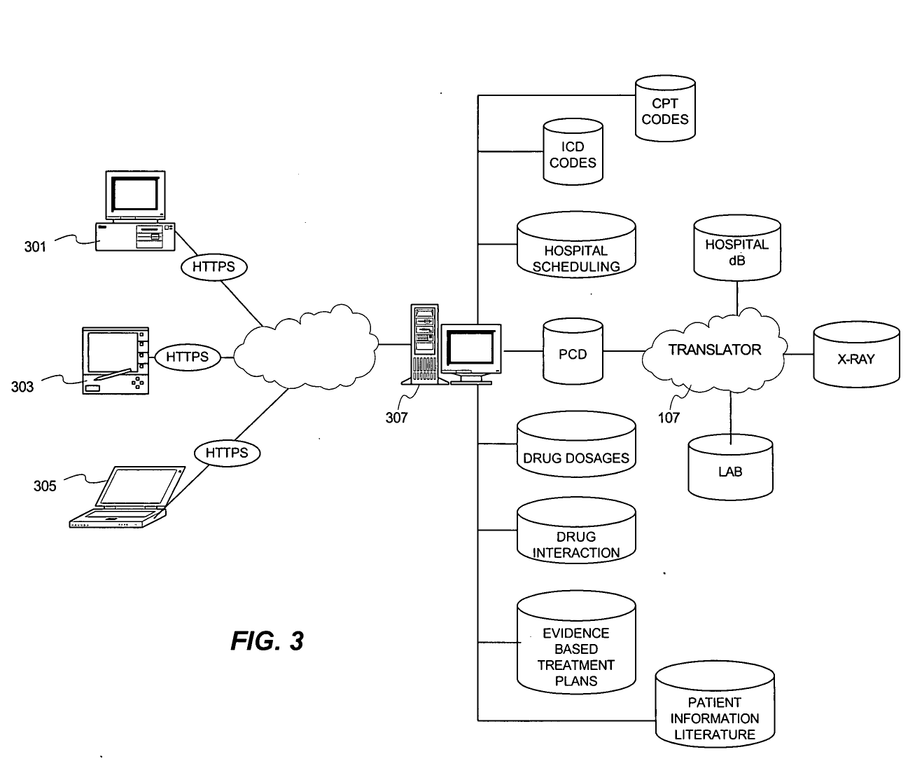

Referring to FIG. 3, data entry of medical information is through any computing device such as desktop computer 301, pen-based computer 303 and laptop 305. preferably using physician-friendly and familiar data entry systems. The use of templates residing in touch sensitive tablet computer 301 connected wirelessly (802.11 “WiFi”) to the central system allows those who wish to use the familiar hand entered technique to continue, while the data is translated into a useable and standardized format. Clients 301, 302 and 303 use a “thin client” software system to ensure the privacy and security of the record. The software automatically codes diagnoses and procedures while organizing the “Evaluation and Management” data to meet Medicare-coding standards. It should be noted that the translation of medical information into standardized format will be required by federal regulations by 2003.

Because reduction of medical errors is one of the objectives of the present invention, many summary lists are maintained in the patient-controlled record 103. Examples of these include a medication list, an allergy list and a problem list. It is intended that the medication list are cross referenced to both the patient's allergy list and to an age-normalized drug dosage table and to an adverse drug interaction table. Reliability of the record is assured by a strict audit trail. Every record entry and record change is logged within the record retaining the date and time of entry, the change, the original record and the author. New information may be entered into the database by several different methods. These include free form entry with keywords (extracted from a dictionary) indexed, a medical/surgical specialty and subspecialty keyed template system, or a questionnaire format.

A “translator” module 107 queries “legacy” (i.e. hospital and other electronic) databases 101. This collects information relating to the individual patient and translates the information from the legacy format (i.e. plain text or NSF format) and rephrase it into standardized vocabulary (HL7, X12). The use of a standard vocabulary allows easy key word searches. Automatic development of problem lists, allergies, drug usage (and therefore flagging of possible drug interactions) and standardized care maps are now feasible. As each hospital might have different legacy systems, programmers may modify the translator to read each individual hospital client's legacy data.

The translator 107 may be custom developed for each hospital. Within defined limits, the hospital may control which information may be transmitted to the PCR. Information is extracted from a variety of hospital databases including:

Demographic files

Chemical and histology laboratories

Imaging reports (text)

Discharge summaries

Operative notes

The translator 107 reads the above files. Utilizing a dictionary of terms, it translates terms used in the legacy system into a standardized terminology (HL7). The use of this terminology is required by HIPAA regulations when financial transactions are transmitted electronically. A series of custom scripts extracts the information into the PCR.

Linked Databases shown in FIG. 3 include databases that are not part of the core Patient Centered Record but are linked and accessible to the user. These include:

CPT codes

ICD codes

Hospital scheduling offices

Admission

Out patient treatment

Surgery

Medical records

Drug dosages

Drug interactions

Evidence-based treatment plans

Patient informational literature

As indicated above, many different systems have entered the market over the past decade. Web-based systems have failed to produce significant market penetration because of an inability to provide a significant financial incentive to allow customer support. Local-based systems are legion. They have the disadvantages listed above for proprietary systems. The system of the present invention overcomes the limitations of the existing systems currently in the market. The benefit to the hospital or physician is readily apparent compared to existing products which are hospital or physician centric and thus require a duplication of information upon a patient switching doctors or hospitals. Although a relatively simple concept, the rest of the industry has obviously missed the true scalability of this product and the resulting monetary and time saving benefits.

Product Summary

Although many electronic medical record systems have been and are being developed, the present invention differs from the others in that it is Internet-based, patient-centered and patient-controlled, provider funded and open source. It is designed to contain a lifetime record rather than events relating to a single provider or group of providers. This unique combination promotes acceptance by patients, physicians and institutions and allows all to experience the obvious benefits of complete, comprehensive, easily available, and robust medical record.

The electronic medical record 103 is formatted for reading over the Internet (e.g., utilizing XML technology) and stored on multiple servers. The PCD database is encrypted and accessible (with patient permission) from anywhere in the world.

Internet-based records make transmission of information among the various health care providers easy, efficient and quick. The internet allows significant information (allergies, previous illnesses, surgery etc.) to be immediately available. Specific medical indications and contraindications (including allergies, age related idiosyncrasies) are part of the record and are linked to appropriate databases (e.g. drug incompatibilities, and age related dosage table) to reduce medical errors. For example, by integrating a prescription with the collected data, the medication record is automatically added to the database. Since the system already knows the patient's medication history and allergic history, risks of adverse drug interactions, allergic reactions and incorrect dosages are eliminated.

As medical knowledge grows, the multiplication of specialties and sub-specialties is inevitable. People are treated by multiple physicians and other practitioners for a single episode of illness. The efficient treatment of an individual depends on prompt and efficient communication among the various treating specialists. Because a quick, efficient means of communication is lacking in today's medical practice, delays in treatment and duplication of effort with its resulting cost is the result. Sometimes the lack of communication leads to medical error. The presence of a complete and timely record easily available to the entire treating staff reduces or eliminate these problems.

In emergency situations, the medical record under the system of the present invention is available in any office or emergency department equipped with a computer and a modem. Each hospital using the system desirably makes it available for the office use of its attending medical staff. For example, the record may begin with a hospital admission. When a patient is admitted to a hospital, the patient is provided with a list of access privileges to be approved by the patient and applied by the hospital and/or physician as agent. The patient-centered database (PCD) queries the hospital legacy systems for initial demographic data including the assigned hospital record number. Using that record number, the PCD collects any information in the hospital's electronic databases and enters that information into the newly developing record. By using templated data entry forms in a wireless tablet computer, the clinical data comprising the present admission is entered in the PCD by treating physicians, house staff and nursing staff. A copy is entered into the hospital record (if desired, a hardcopy can be prepared for a paper record). Data is retrieved into the tablet P.C. as needed but is not stored there (thin client technology). Data is permanently stored only in a secure server 307 (shown in FIG. 3) where it is encrypted for further protection. This allows automatic compliance with HIPAA privacy regulations.

Additional information collected by the hospital's legacy systems (laboratory, radiology, operative notes, discharge summaries) are also copied to the PCD as needed. Our “translator” module queries “legacy” (i.e. hospital and other electronic) databases. This collects information relating to the individual patient and translates it from the legacy format (i.e. plain text or NSF format) and rephrases it into standardized vocabulary (HL7, X12). The use of a standard vocabulary allows easy key word searches. Automatic development of problem lists, allergies, drug usage (and therefore flagging of possible drug interactions) and standardized care maps now become feasible. As each hospital might have different legacy systems, the system is readily customized by modifying the translator processes to read each individual hospital client's legacy data.

From this information the hospital billing system can assemble needed financial data via exporting data from our system in a format that is compliant with HIPAA electronic billing regulations. Documentation needed to support CPT (common procedural terminology) and ICD-9 (International Classification of Diseases) coding is provided by CPT and ICD Code databases shown in FIG. 3, which are the basis on which billing is approved by insurers. Hospital requests for payment are rejected if the coding does not match the diagnosis. Thus, the system of the present invention results in a reduction in the timing to get reimbursed.

After discharge, the record data entry source changes to the physician's office. The treating physician and others who enter data into the record authenticates their notes by an electronic signature. These staff members utilize electronic signatures to authenticate other hospital record components (discharge summary, operative notes, orders, etc.) Because this may be done using the tablet computer provided or from the comfort of the office or home using a personal computer, a time wasting annoyance is eliminated and physician morale is improved. This translates into increased loyalty to the providing hospital, a dramatic competitive advantage.

On arrival at the physician's office, the patient presents his password key. This grants the physician the right to enter data into the PCD and to read the data previously accumulated in the PCD. Access may be limited by the patient as he sees fit. The physician may (with permission) copy this data to his own office record.

The treating physician, if authenticated as a system agent (any authorized user with a defined set of privileges), now enters further data into the PCD. He may use the templated data entry forms that are provided for each specialty and subspecialty. The software generating these forms is flexible enough to allow the physician to personalize the format to suit his needs and idiosyncrasies. Note that the use of templated data entry forms reduces the record keeping time for the physician and maximizes his financial reimbursement by accurately documenting the evaluation and management component of his billing procedure. Although the PCD does not contain billing information, the encounter may be used by the physician's or hospital's own electronic accounting system to prepare bills and complete financial statements by exporting data from our system in a format that is compliant with HIPPA electronic billing regulations.

When the patient changes physicians, the PCD, with patient permission becomes available to the new treating physician or other provider. This gives the provider the right to read and copy any portion of the record for which privilege is granted by the patient. Because the record is internet-based, in order to write to the record, the new provider only needs access to the internet. He may place data into the record by any convenient electronic means; if he utilizes one of the available templates, the system parses the data and indexes significant findings.

The benefits to the individual patient, to the physician in private practice and the hospital are numerous. Examples of these benefits are as follows:

Patient Benefits:

Elimination of risk of medical errors

Elimination of redundant paper work

Instant availability of patient medical history, laboratory records and imaging data

Reduction of risk of drug incompatibility or allergy reaction or dosage errors

Reduction in cost and time associated with duplication of services (similar x-rays, blood work etc.)

Physician Benefits:

Automatic edit of CPT (common procedure technology) coding resulting in increased physician income and reduction in paperwork

Ease of completing hospital paperwork, i.e., discharge summaries, admissions summaries, attestations, surgical scheduling

Use of templated forms reduces the record keeping time for the physician Reduction in delays for payment of services.

Hospital Benefits:

Reduction of “hassle factor” (admissions, paper work etc.) increases loyalty of medical staff

Increased hospital efficiency and automatic compliance with HIPPA

Data compiled for internal hospital efficiency review and studies

Reduction in payment delays.

Effective use of CPOE systems

Summary of basic principles of the PCD.

Patient centered and patient controlled—the individual controls (by means of password or other key) access to the medical record. Patient privacy is automatic while access by needed health care entities is not inhibited.

Lifetime record—not limited to a specific provider or group of providers.

Open source—the system utilizes freely available public software to generate its system. (XML, MySql etc). The use of open source software promotes software that remains robust and legible with the passage of time and minimizes the risk of data loss because of business failures (including our own). The HL7 vocabulary is utilized so that compliance with HIPPA mandates is assured.

Internet connected—a properly encrypted Internet-based system allows access from anywhere that the Internet is available (essentially the entire civilized world). Because this is a distributed database, it is robust and independent of the failure of any individual server or any other piece of hardware.

The system comprises two components:

A first component comprises a patient centered database containing the electronic medical record for that individual. The system is patient controlled. No data may be read from the record unless access is specifically granted by the owner of the record (the patient). With patient permission, the system allows any authorized health care provider to write directly into the system, authorization to read from or copy from the system can only be provided by the patient and he/she can limit access to any portion of the database. Each provider has the right to a copy of their own inputs.

Each agent as designated by the patient has an assigned set of privileges.

The record is marked in specific segments:

Hospital notes

Laboratory studies

Imaging studies (further subcategorized into text reports and images)

Outpatient notes

Physician office records (further subcategorized by the specific physician who authored the notes)

Diagnosis List (may be further subcategorized into “sensitive” [e.g. psychiatric, AIDS] and “non-sensitive”)

Treatment List

Problem List

Medication List

Each of these segments has an assigned “read-only” “write-only” or “read and write” privilege. There is a default list of privileges for every agent. For example:

Primary physician—read all, write to office record, diagnosis, treatment and problem lists.

Physical therapist—read “non-sensitive” diagnosis list read and write own record

Clinical laboratory—write only to laboratory studies.

Insurance co.—read only “non-sensitive” diagnosis list, treatment list.

The patient may edit this privilege list and add other agents. All records are permanent in that all changes contain both the original note, the change, the author of both the original note and the change with all changes dated and timed. Agents require authentication to enter the record.

The records 103 may include a clinical event notes log-comprising but not limited to information such as history, clinical examination, secondary (follow-up) notes, summary notes (hospital discharge summaries, surgical notes), problem list medication list, demographic information, appointment, text-based laboratory reports, image-based reports, provider list, security log, designated agents and privileges, access log including time, date and author of entry, or other information desired for a particular application.

A second component comprises a translator to query legacy databases such as laboratory, radiology, surgical and demographic to extract specific information pertinent to the individual patient. This information is parsed for entry into the specific fields of the Patient Centered Database (PCD)

In the hospital environment an optional flexible templated data entry system is utilized by clinical staff to enter new data into the medical record. The physician, nurse or other authorized clinical staff may call up any portion of the clinical record for which they have privileges. To enter new data a template is called, Data is then entered using simple check marks. This mode of data entry lends itself to the use of a tablet type touch screen wireless computer. There are multiple templates developed for each specialty and sub-specialty. Utilizing a simplified template language, the system can be optimized by the individual physician. This permits freedom of action on the part of the entering physician while maintaining the standardized vocabulary of the database. The templates are available to the private physician on an optional basis.

The templated system of data entry has many advantages to the physician. It allows documentation to fit the CPT criteria for Evaluation and Management. The CPT criteria is the five-step code that determines the payment level of physician services. By using a standardized entry system, the physician is assured of the maximum legal payment for his services. This is an obvious significant added value.

This system of data entry may also be used in the physician's office and is offered as an option. The system retrieves data from the physician's office in any electronic format and preferably does not require a change in practice. Because of the standardization of data entry, the information is parsed and used to facilitate medical care. The following are examples of useful lists generated by the program.

Problem list—this presents patient's medical problems in chronological order and the date of the solution of the specific problem (if problem has been solved)

Diagnoses with diagnostic codes provided.

Surgery—name of surgical procedure, institution where performed and date of procedure

Allergies—list of all known allergies (environmental or drug)

Medications—list of all medications taken, date begun and date completed. This list may be used to query a database of known drug interactions and flag a warning if needed

Family history including hereditary diseases and specific genetic information as it becomes available.

Once a diagnosis and course of treatment has been determined, the information is used to compare with a database of best practice protocols as published by the various specialty organization.

CPOE—A computerized data entry system is part of the hospital implementation of our system. Because the entire patient history is available to the system, the problem of missed allergies or medication dosages inappropriate to age or condition is immediately noted. The system compliments but is not required to replace any provider-based system so that legacy systems now in place in offices or institutions may continue to function. If, however the provider finds that it is in his interest to do so, the system can be used to act as an institutional medical record system.

Data entry can be through any computer but present physician resistance required the development of easy and familiar data entry systems. The use of templates residing in touch sensitive tablet computers connected wirelessly (802.11b or 802.11a) to the central system allows those who wish to use the familiar hand entered technique to continue while the data is translated into a useable and standardized format. It should be noted here that the translation of medical information into standardized vocabulary (HL7) will be required by the federal regulations by 2003.

1. Hardware

Designated wireless tablet computers—These are utilized to enter data on both hospitalized and office patients. Designated wireless tablet computers are about the size and shape of a standard hospital chart and, utilizing “Wi-fi” technology, can be carried on rounds in the familiar fashion. Notes may be entered in either form or (preferably) entered into a standardized template. To deter theft, institutional logos are applied and the unit can be equipped with an alarm system which sounds when unit is moved from designated area.

Location specific designated “hot keys” are imprinted on the keyboard to increase the ease of use, e.g. Laboratory, X-ray, Order sheet, Library search etc. Specific client (hospital) templates and other custom software are pre loaded. Separate data entry format for physician, nurse, ancillary personnel. Similar hardware is made available for use in the physician's office. The equipment may be leased (to reduce the physician's capital cost while insuring a continuing cash flow to our company).

Although there are many other electronic medical systems on the market, only the present invention combines the three elements of patient centered and controlled, internet access and open source software. A patient centered record places lifetime medical records in a single accessible collection. Most competitive systems are provider centered. This guarantees that records of other providers or records stored in other places are unavailable. There are many obstacles to the sharing of records by multiple providers. These difficulties can only work to the detriment of the patient and increase the risk of medical errors because of adverse drug interactions or the loss of essential information.

Privacy of the medical record is a recurrent problem in all systems. HIPAA regulations are a governmental attempt to mitigate this problem. When access to the record is patient controlled, privacy issues are automatically considered and patient consent becomes an integral part of the system. Secure internet access eliminates geographic obstacles to the availability and use of the medical record. With the use of secure servers and distributed databases, the risk of data loss is greatly reduced. The use of the internet by financial and governmental institutions testifies to the usefulness and security of this method.

All electronic data is formatted in some fashion for storage and transmission. Proprietary coding systems die when the system is changed or the provider ceases to exist (business failure, merger, etc). The robustness and longevity of medical data are essential for the functioning of any electronic record system. Because open source formats are in the public domain, the information remains available whatever the fate of the original provider.

The combination of the above benefits work to create a strong allegiance between the hospital and the physician. Our products ability to reduce the “hassle factor” via increasing the ease for the Doctor of completing hospital paper work (admission and discharge summaries, attestations, surgical scheduling) strengthens the loyalty of the doctor to the hospital thereby providing the hospital with an increase in admissions and a competitive advantage in their market. Both the doctor and the hospital become more efficient from a time perspective, comply with government regulations and increase their ability generate to more income. None of our competitors offer these benefits.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of handling patient medical information, the method comprising:
for a patient, creating a patient-centric electronic medical record by storing a plurality of data items about the patient in a patient-centric data structure;
establishing access permissions for the medical record, wherein the access permissions are patient-controlled; and
wherein the electronic medical record is owned by the patient and includes data items associated with an arbitrary number and variety of health care providers that have been used by the patent over the patient's lifetime.

2. The method of claim 1 in which the patient-centric electronic medical record further comprises:
enabling the patient to control access to the patient-centric electronic medical record.

3. The method of claim 1 further comprising transporting the patient-centric electronic medical record over the Internet in accordance with the patient-controlled access permissions.

4. The method of claim 2 further comprising:
specifying within the patient-centric electronic medical record specific access privileges for independently for each entity, including health care providers, physicians, hospitals, insurance companies, health maintenance organizations, and government agencies that may access the patient-centered record.

5. The method of claim 3 in which the act of establishing access permissions comprises establishing a right to read the patient-centric electronic medical record, write to the patient-centric electronic medical record and copy parts of the patient-centric electronic medical record; and
wherein each of the access permission are controlled by the patient.

6. The method of claim 4 further comprising:
providing patient-determined restrictions on access privileges to specific parts of the patient-centric electronic medical record.

7. The method of claim 6 in which the restriction of access privileges are determined in part by time of entry or place of entry.

8. The method of claim 1 further comprising:
querying a legacy datastore to select legacy records related to the patient to obtain at least some of the data items about the patient;
upon determining that a selected legacy record is in a non-open source format, translating the selected record to an open source format before storing the selected record as a data item in the patient-centric electronic medical record.

9. The method of claim 5 further comprising:
using a specific client-optimized dictionary to translate legacy records into standardized terminology; and
storing the translated legacy record as a data item in the patient-centric electronic medical record d.

10. An open source medical record system using the method of claim 1.

11. The method of claim 1 in which the patient-centric electronic medical record uses a standardized vocabulary-based on the standard XML-HL7.

12. The method of claim 1 further comprising maintaining the patient-centric electronic medical record as a secure internet-based record data set.

13. The method of claim 1 further comprising:
storing the patient-centric electronic medical record in an encrypted, secure server.

14. The method of claim 13 further comprising:
decrypting the patient-centric electronic medical record only in response to a private key provided by the patient.

15. The method of claim 14 further comprising:
providing encryption/decryption software to encrypt and decrypt the patient-centric electronic medical record to a local computer on a temporary basis by the secure server; and
deleting the encryption/decryption software from the local computer when it is no longer needed to encrypt or decrypt the patient-centric electronic medical record.

16. The method of claim 1 in which costs and expenses associated with the providing and/or maintaining the patient-centric electronic medical record are hospital financed and provided to patients via their physicians and/or through a hospital.

17. The method of claim 1 further comprising:
cross-referencing summary medication lists stored as data items in the patient-centric electronic medical record to drug interaction tables and age appropriate dosage tables to reduce of medical errors.

18. The method of claim 1 in which the patient-centric electronic medical record comprises summary allergy lists.

19. The method of claim 1 further comprising:
entering data items into the patient-centric electronic medical record using wireless hand held computers.

20. The method of claim 1 further comprising:
entering data items into the patient-centric electronic medical record using “thin client” technology so that the patient-centric electronic medical record is persistently stored only on secure, encrypted servers.

21. The method of claim 15 wherein plain-text data items from the electronic medical record exist in a local computer only in volatile memory and non-volatile storage of the data items is allowed only on the server and only in encrypted form.

22. The method of claim 1 further comprising using templated data entry forms.

23. The method of claim 22 wherein the templated data entry forms comprise medical/surgical specialty and sub-specialty specific templates.

24. The method of claim 1 further comprising using free form record entries.

25. The method of claim 1 further comprising using indexed keywords in free form record entries.

26. The method of claim 3 further comprising:
maintaining an audit trail within the medical record in which every change to a patient-centric electronic medical record is logged by date and time of entry retaining the original record, the record change and a value indicating the identity of the author or initiator of the change.
